(19) United States
(12) Patent Application Publication
(10) Pub. No.: US 2015/0095391 A1
(43) Pub. Date: Apr. 2, 2015

(54) Determining a Product Vector for Performing Dynamic Time Warping

(71) Applicants: Mrugesh Gajjar, Bangalore (IN); Nagavijayalakshmi Vydyanathan, Bangalore (IN)

(72) Inventors: Mrugesh Gajjar, Bangalore (IN); Nagavijayalakshmi Vydyanathan, Bangalore (IN)

(21) Appl. No.: 14/503,079

(22) Filed: Sep. 30, 2014

(30) Foreign Application Priority Data
Sep. 30, 2013 (IN) 1129/KOL/2013

(51) Int. Cl. G06F 17/16

(52) U.S. Cl. CPC G06F 17/16
USPC 708/441

(57) ABSTRACT

A method and a system for determining a product vector for computation of a Euclidean distance for performing Dynamic Time Warping of a test signal and a template signal are provided. Low-rank factorized vectors are determined for the template signal. The low-rank factorized vectors are processed along with the test signal for determining the product vector. The product vector is thereafter usable for the determination of a Euclidean distance between the test signal and the template signal, and for performing dynamic time warping of the test signal and the template signal.

This application claims the benefit of IN 1129/KOL/2013, filed on Sep. 30, 2013, which is hereby incorporated by reference in its entirety.

### BACKGROUND

The present embodiments relate to the field of Dynamic Time Warping of signals.

Modern day signal processing applications, such as Dynamic Time Warping, Data Compression, Data Indexing, Image Processing, etc., involve tremendous amounts of data processing. The different signals involved may be represented as matrices, which include a vast multitude of vectors. The data processing involved thereof includes mathematical computations and mathematical transformations, such as matrix additions, matrix multiplications, matrix inversions, determination of Fast Fourier Transforms, etc. Signal processing applications that involve matrix multiplications and dot product computations (e.g., when the matrices are of immense dimensions and/or orders) may be both time consuming and resource intensive, because of the number of multiplicative and additive operations that are to be performed for the determination of one or more intermediate results and/or the final result.

For example, in the domain of Dynamic Time Warping, one or more Euclidean distances are to be determined for two input signals, prior to the computation of a Dynamic Time Warping Score for the two input signals. The computation of the Euclidean distances involves the determination of a product of the two input signals. Therefore, the speed of performing Dynamic Time Warping on the two input signals is dependent on the speed of determination of the product of the two signals. Therewith, the speed of performing Dynamic Time Warping may be enhanced by reducing the time for the determination of the product of the two input signals.

Currently, the product of two matrices, where the matrices represent signals, is determined by direct multiplication of the matrices. However, the direct multiplication of the matrices is expensive in terms of both time and the resources that are used to determine the product thereof. Thus, the current technique poses impediments, especially for very high speed and highly data intensive applications, because latency is introduced in the determination of the final result.

### SUMMARY AND DESCRIPTION

The scope of the present invention is defined solely by the appended claims and is not affected to any degree by the statements within this summary.

A need exists to increase a speed of determination of a product of signals, therewith increasing the speed of the different mathematical computations involved, and the performance of the signal processing applications thereof. For example, in the context of Dynamic Time Warping, an increase in the speed of determination of the product of the two signals also increases the speed of determination of the Euclidean distances associated therewith, thereby leading to a reduction in the time required for performing Dynamic Time Warping.

The present embodiments may obviate one or more of the drawbacks or limitations in the related art. For example, an enhanced solution for increasing the speed of determination of the product of the two signals is provided.

The determination of a product of two signals (e.g., a test signal vector and a template signal; when the two signals are expressed as matrices) is simplified. A simplified determination of the product of the two signals is beneficial in reducing the time and resources used (e.g., in time and resource intensive signal processing applications, such as performing Dynamic Time Warping of the two signals, in which the Euclidean distance of the two signals is to be determined based on the product of the two signals).

In one or more of the present embodiments, a method is to determine a product vector of a test signal vector and a template signal vector is provided. The test signal vector is a collection of vectorized values of a portion of a test signal. The template signal vector is a collection of vectorized values of a template signal. The template signal vector is factorized, whereby a first and second template signal factorized vectors are obtained. Ranks of both the first and the second template signal factorized vectors are less than a rank of the template signal vector. The test signal vector is thereafter multiplied with the first template signal factorized vector, wherewith an intermediate test signal vector is obtained. The intermediate test signal vector is thereafter multiplied with the second template signal factorized vector, wherewith the product vector is obtained.

The low-rank factorization of the template signal vector simplifies the determination of the product of the test signal and the test signals, because the number of computations that are used to determine the product vector is reduced. The low-rank template signal factorized vectors consume lesser memory space for storage as compared to the entire template signal vector, because of the diminished ranks of the first and the second template signal factorized vectors as compared to the template signal vector.

In accordance with an embodiment, a product of the first and the second template signal factorized vectors is an approximation of the template signal vector. Herewith, the memory used for storing the first and the second template signal factorized vectors are further reduced, because the storage of accurate vectorized values of the template signal vector uses more memory space.

In accordance with yet another embodiment, a random signal is multiplied with the template signal vector, and a quasi product vector is therewith obtained. The random signal is a collection of vectorized values of a random signal. The quasi product vector is factorized, wherewith a first and a second quasi product factorized vectors are obtained. Thereafter, the first quasi product factorized vector is multiplied with an inverse random signal, wherewith the first template signal factorized vector is obtained. In a further embodiment, the low-rank factorization of the quasi product vector is such that the second quasi product factorized vector is the second template signal factorized vector. An alternate embodiment for the purpose of factorization of the template signal vector may be realized.

In accordance with another embodiment, the template signal vector and/or the quasi product vector is factorized into low-rank factors by performing Singular Value Decomposition on the same. Singular Value Decomposition is a well-known method and follows a simple implementation of the same for the purpose of obtainment of the low-rank factors of the template signal.

A method for performing Dynamic Time Warping of the test signal vector and the template signal vector, based on the product vector obtained in accordance any of the aforementioned embodiments is disclosed herein. The product vector is processed along with the test signal vector and the template signal vector, wherewith a Euclidean distance between the test signal vector and the template signal vector is obtained. Thereafter, the Euclidean Distance is processed to obtain a global distance between the test signal vector and the template signal vector, wherewith a Dynamic Time Warping Score is obtained. The Dynamic Time Warping Score is a measure of the similarity between the test signal vector and the template signal vector.

A system disclosed herein, for the purpose of determination of the product vector of the test signal vector and the template signal vector, includes a factorization module, a first multiplication module and a second multiplication module. The factorization module is operably coupled to the first multiplication module, and the first multiplication module is operably coupled to the second multiplication module. The template signal is factorized by the factorization module, wherewith the first and the second template signal factorized vectors are obtained. Thereafter, the first template signal factorized vector and the test signal vector are multiplied by the first multiplication module, wherewith the intermediate test signal vector is obtained. The intermediate test signal vector is thereafter multiplied with the second template signal factorized vector by the second multiplication module, wherewith the product vector is obtained.

In accordance with an embodiment, the template signal vector is factorized by the factorization module such that the product of the first and the second template signal factorized vectors yield at least an approximation of the template signal vector.

In accordance with another embodiment, the factorization of the template signal by the factorization module is accomplished by performing Singular Value Decomposition of the template signal vector.

In accordance with yet another embodiment, a third multiplication module is provided therein. The multiplication of the random signal and the template signal vector is facilitated by the third multiplication module for the purpose of obtainment of the quasi product vector.

In accordance with yet another embodiment, the quasi product vector is factorized by the factorization module, therewith obtaining the first and the second quasi product factorized vectors. The factorization is such that the second quasi product factorized vector is the second template signal factorized vector.

In accordance with yet another embodiment, a fourth multiplication module is provided therein. The multiplication of the inverse random signal and the first quasi product factorized vector is facilitated by the fourth multiplication module.

In accordance with yet another embodiment, the first multiplication module is configured to perform the multiplication of the first template signal factorized vector and the second quasi product factorized vector. Therewith, the product vector is obtained.

In accordance with yet another embodiment, a memory unit is provided. The memory unit is beneficial for storing the test signal vector, the template signal vector, the product vector, the first template signal factorized vector, and/or the second template signal factorized vector.

A Dynamic Time Warping Block for performing Dynamic Time Warping of the test signal vector and the template signal vector is disclosed herein. The Dynamic Time Warping Block includes the system according to any of the embodiments, a Euclidean Distance Matrix Computation module, and a Dynamic Time Warping Score computation module. The Euclidean distance between the test signal vector and the template signal vector is computed by the Euclidean Distance Computation module. The Euclidean distance is provided to the Dynamic Time Warping Score computation module, wherewith the Euclidean Distance is processed, and the global distance between the test signal vector and the template signal vector is determined. The global distance represents the Dynamic Time Warping Score for the test signal vector and the template signal vector. The Dynamic Time Warping Score represents a similarity between the test signal vector and the template signal vector.

### BRIEF DESCRIPTION OF THE DRAWINGS

Like numbers refer to like parts throughout the description and drawings.

FIG. 1 shows an overview of a system for determining a product vector of a test signal vector and a template signal vector according to one or more embodiments;

FIG. 2 shows an exemplary embodiment of the system of FIG. 1;

FIG. 3 shows another embodiment of the system of FIG. 1;

FIG. 4 shows one embodiment of a Dynamic Time Warping Block including the system of FIG. 1 for determining a Dynamic Time Warping Score of the test signal vector and the template signal vector;

FIG. 5 shows a flowchart of one embodiment of a method for determining a product vector;

FIG. 6 shows acts of the method of FIG. 5 with reference to another embodiment; and

FIG. 7 shows a flowchart of one embodiment of a method for performing Dynamic Time Warping of the test signal vector and the template signal vector.

### DETAILED DESCRIPTION

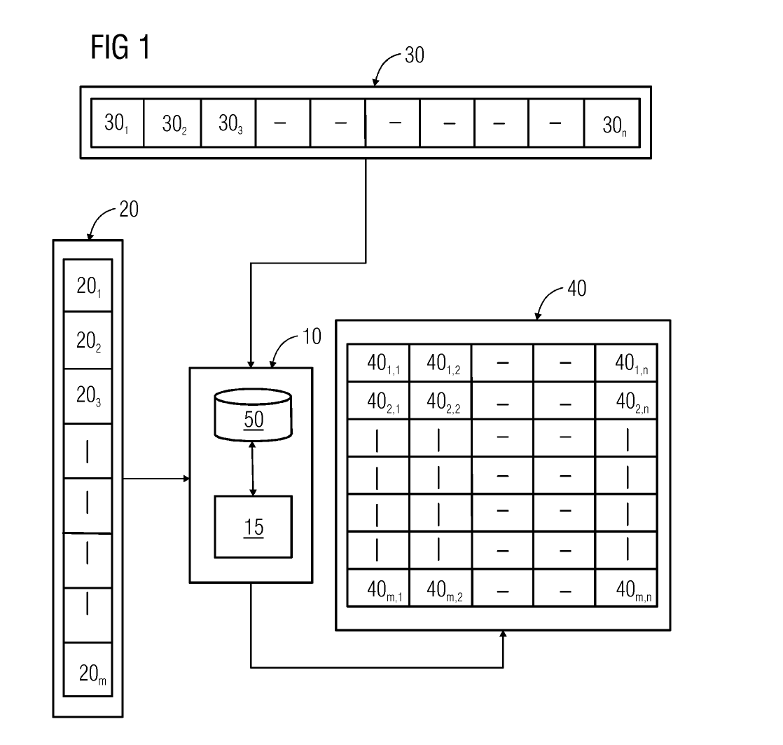

An overview of a system 10 for determining a product vector 40_{1,1} from a test signal vector 20₁ and a template signal vector 30₁ in accordance with one or more embodiments is shown in FIG. 1.

A plurality of test signal vectors 20 (e.g., ‘m’ number of exemplary test signal vectors 20₁-20ₘ) is shown in FIG. 1. Each test signal vector 20₁-20ₘ includes vectorized values of at least a portion of a test signal (not shown) (e.g., the vectorized values of the test signal vector 20₁-20ₘ may correspond to respective discrete-time sampled values of the portion of the test signal). The test signal may correspond to a discrete-time signal, such as a discrete-time speech signal, a discrete-time video signal, a discrete-time image signal, a discrete-time temperature signal, etc.

An exemplary manner of obtainment of the ‘m’ number of exemplary test signal vectors 20₁-20ₘ is described below. The test signal may be windowed in time domain, where a certain time domain window of the test signal corresponds to the portion of the test signal. Thereafter, the respective discrete-time sampled values that correspond to the portion of the test signal may be arranged accordingly to obtain the corresponding test signal vector 20₁-20ₘ. Thus, sequentially arranged test signal vectors 20₁-20ₘ correspond to respective vectorized values of sequential portions of the test signal (e.g., respective collections of sequential discrete-time sampled values of sequential time-domain windowed portions of the discrete-time test signal).

If a number of discrete-time sampled values in each of the time domain windows is ‘d’, then a length of each test signal vector 20₁-20ₘ is construed to be ‘d’. Therefore, each test signal vector 20₁-20ₘ is representable as a ‘l×d’ matrix (e.g., ‘l’ row, and ‘d’ number of columns). Each column is construed to represent respective vectorized values of the respective portions of the test signal.

For the purpose of visualization, the plurality of ‘m’ number of test signal vectors 20, as depicted in FIG. 1, are arranged in the form of an ‘m×d’ dimensional matrix (e.g., ‘m’ number of rows, and ‘d’ number of columns). Each row represents a particular test signal vector 20₁-20ₘ, and each column represents the corresponding vectorized values of that particular test signal vector 20₁-20ₘ.

Hereinafter, the plurality of test signal vectors 20 that is arranged in the form of an ‘m×d’ dimensional matrix will be referred to as “the ‘m×d’ test signal matrix 20”.

A plurality of template signal vectors 30 (e.g., ‘n’ number of exemplary template signal vectors 30₁-30ₙ) is depicted in FIG. 1. Each template signal vector 30₁-30ₙ includes vectorized values of at least a portion of a template signal (not shown). The vectorized values of the portion of a template signal refer to the respective discrete-time values of the portion of the template signal.

The template signal vectors 30₁-30ₙ serve as model signals for the purpose of comparison of the test signal vector 20₁-20ₘ with one or more template signal vectors 30₁-30ₙ for the purpose of determination of respective degrees of similarity between the test signal vector 20₁-20ₘ and the respective template signal vectors 30₁-30ₙ. The template signal vector 30₁-30ₙ that is approximately similar to the test signal vector 20₁-20ₘ may thereafter be selected. This is useful for performing certain signal processing applications such as Dynamic Time Warping, Data Compression, Data Indexing, etc.

A length of each template signal vector 30₁-30ₙ is also ‘d’ (e.g., ‘d’ number of samples is included in each of the template signal vector 30₁-30ₙ). However, in one embodiment, each template signal vector 30₁-30ₙ is representable as a ‘d×l’ matrix (e.g., ‘d’ number of rows, and ‘l’ column). Each row may represent the respective vectorized values of the respective portion of the template signal

For the purpose of visualization and for the purpose of facilitation of the processing of a particular test signal vector 20₁-20ₘ and the plurality of template signal vectors 30₁-30ₙ, the plurality of template signal vectors 30₁-30ₙ is arranged in a columnar contiguous manner, which is representable in the form of a ‘d×n’ dimensional matrix (e.g., ‘d’ number of rows and ‘n’ number of columns). The columnar contiguous arrangement of the template signal vectors 30₁-30ₙ as the ‘d×n’ matrix is beneficial for matrix multiplication of the ‘m×d’ test signal vectors 20₁-20ₘ and the ‘d×n’ template signal matrix 30.

Hereinafter, the plurality of ‘n’ number of ‘d×l’ template signal vectors 30₁-30ₙ that is arranged in the form of an ‘d×n’ dimensional matrix will be referred to as “the ‘d×n’ template signal matrix 30”.

If ‘n’ is greater than ‘d’, then a rank of the ‘d×n’ template signal matrix 30 may not exceed ‘d’. Similarly, if ‘n’ is lesser than ‘d’, then the rank of the ‘d×n’ template signal matrix 30 may not exceed ‘n’. In one embodiment, ‘n’ is greater than ‘d’.

A plurality of product vectors 40 (e.g., ‘m×n’ number of exemplary product vectors 40_{1,1}-40_{m,n}) is depicted in FIG. 1. An exemplary product vector 40_{1,1}-40_{m,n} is to be construed as a vector-based dot product of an exemplary test signal vector 20₁-20ₘ, and an exemplary template signal vector 30₁-30ₙ. A respective product vector 40_{1,1}-40_{m,n} is determined as a dot product of a respective test signal vector 20₁-20ₘ and a respective template signal vector 30₁-30ₙ. The plurality of product vectors 40_{1,1}-40_{m,n} is construed to be an ordered arrangement of the corresponding dot products of the respective plurality of test signal vectors 20 and the respective plurality of template signal vectors 30. Therefore, ‘m×n’ number of product vectors 40_{1,1}-40_{m,n} may be determined, because of the presence of ‘m’ number of test signal vectors 20₁-20ₘ and ‘n’ number of template signal vectors 30₁-30ₙ.

The length ‘d’ of the exemplary test signal vector 20₁-20ₘ and the length ‘d’ of the exemplary template signal vector 30₁-30ₙ are identical, for the purpose of determination of the dot product of the test signal vector 20₁-20ₘ and the template signal vector 30₁-30ₙ. Therewith, an entire length of the exemplary product vector (e.g., the corresponding dot products of the respective exemplary test signal vectors 20₁-20ₘ and the respective exemplary template signal vectors 30₁-30ₙ) 40_{1,1}-40_{m,n} is also ‘m×n’.

For the purpose of visualization, the plurality of product vectors 40_{1,1}-40_{m,n} is arranged in the form of an ‘m×n’ dimensional matrix (e.g., ‘m’ number of rows and ‘n’ number of columns).

Hereinafter, the plurality of product vectors 40_{1,1}-40_{m,n} that is arranged in the form of an ‘m×n’ dimensional matrix will be referred to as “the ‘m×n’ product vector matrix 40”.

In one embodiment, if ‘m’ is greater than ‘n’, then a rank of the ‘m×n’ product vector matrix 40 may not exceed ‘n’. Similarly, if ‘m’ is lesser than ‘n’, then the rank of ‘m×n’ product vector matrix 40 may not exceed ‘m’.

In the subsequent paragraphs, one or more of the present embodiments will be descried specifically with respect to an exemplary test signal vector 20₁-20ₘ and the ‘d×n’ template signal matrix 30 (e.g., the plurality of template signal vectors 30₁-30ₙ) for the purpose of determination of an exemplary product vector 40_{1,1}-40_{m,n}. However, without loss of generality, the teachings of one or more of the present embodiments may be utilized and extended thereon to determine the product vectors 40_{1,1}-40_{m,n} corresponding to the remaining test signal vectors 20₁-20ₘ, should there be a scenario, which may be the case in practical signal processing applications such as Dynamic Time Warping, where a multitude of test signal vectors is present.

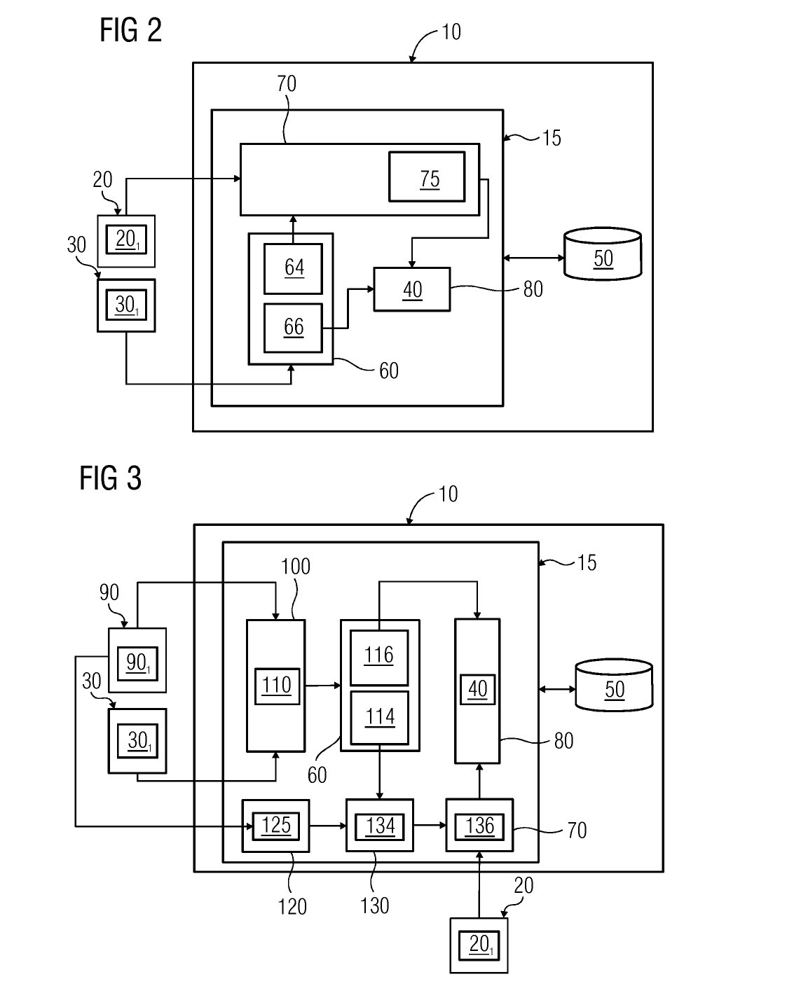

The system 10 of FIG. 1, along with the various embodiments thereof, is configured to receive each of the test signal vectors 20₁-20ₘ and the ‘d×n’ template signal matrix 30, and process each of the test signal vectors 20₁-20ₘ and the ‘d×n’ template signal matrix 30 for the determination of the respective product vectors 40_{1,1}-40_{m,n} thereof. The processing of the test signal vectors 20₁-20ₘ and the ‘d×n’ template signal matrix 30 involves the determination of the dot products thereof. FIG. 1 is only a high level depiction of the system 10, and the various embodiments thereof are described with reference to FIG. 2 and FIG. 3.

The system 10 includes a processing unit 15 to receive the test signal vector 20₁-20ₘ and the plurality of template signal vectors 30 and to process the same to determine the respective product vector 40_{1,1}-40_{m,n} thereof. The various components (e.g., described in the subsequent paragraphs) of the processing unit 15 may be implemented using one or more hardware modules, software modules, or combinations thereof. For example, if the system 10 is implemented using a hardware unit, then the processing unit 15 may be realized by a processor of a General Purpose Computer, an Application Specific Integrated Circuit, a Field Programmable Gate Array Device, a Complex Programmable Logic Device, etc.

In accordance with an embodiment of the present system 10, a memory unit 50 is provided, and the memory unit 50 is operably coupled to the processing unit 15 for enabling data transfer between the processing unit 15 and the memory unit 50. The memory unit 50 facilitates the storage of one or more test signal vectors 20₁-20ₘ, one or more template signal vectors 30₁-30ₙ, and/or one or more product vectors 40_{1,1}-40_{m,n}, etc. The memory unit 50 is realizable as a database capable of being queried for obtaining data therefrom, where the test signal vectors 20₁-20ₘ and/or the template signal vectors 30₁-30ₙ may be provided to the processing unit 15 for the determination of the corresponding product vectors 40_{1,1}-40_{m,n}. The coupling between the processing unit 15 and the memory unit 50 may be wired, wireless, or a combination thereof. According to an aspect, the memory unit 50 may be internal to the processing unit 15, and the entire system 10 may be the processing unit 15 including the memory unit 50 (e.g., the memory unit 50 may be an internal cache memory of the processing unit 15). Alternatively, according to another aspect, the memory unit 50 may also be located external to the processing unit 15 (e.g., the memory unit 50 may be remotely located as compared to the processing unit 15).

The matrix-arrangements 20, 30, 40, which may correspond to the plurality of test signal vectors 20, the plurality of template signal vectors 30, and/or the plurality of product vectors 40, are depicted for illustrative purposes. The actual manner in which the matrix-arrangements 20, 30, 40 are stored in the memory unit 50 and/or processed by the processing unit 15 of the system 10 depends on the architecture of the system 10 and/or the architecture of the memory unit 50.

In the subsequent paragraphs, two exemplary embodiments of the system 10 are described. The exemplary embodiments of the system 10 are utilized for the determination of the product vector 40_{1,1}-40_{m,n} by processing each of the test signal vectors 20₁-20ₘ and the ‘d×n’ template signal matrix 30. A first exemplary embodiment is described with reference to FIG. 2, and a second exemplary embodiment is described with reference to FIG. 3.

The system 10 in accordance with the first exemplary embodiment is depicted in FIG. 2.

FIG. 1 is also referred to herein for the purpose of the description of FIG. 2. The system 10 includes a factorization module 60, a first multiplication module 70, and a second multiplication module 80 for the determination of the product vector 40_{1,1}-40_{m,n}. The factorization module 60, the first multiplication module 70, and the second multiplication module 80 may be realized as hardware modules, software modules, or combinations thereof. The functioning of the modules 60, 70, 80 is described in the subsequent paragraphs.

In accordance with one or more aspects of the first exemplary embodiment, the factorization module 60 is configured to receive the ‘d×n’ template signal matrix 30 in order to factorize the ‘d×n’ template signal matrix 30 (e.g., into a first template signal factorized vector 64 and a second template signal factorized vector 66). To achieve the purpose of faster and more efficient computation of the product vector 40_{1,1}-40_{m,n}, ‘d×n’ template signal matrix 30 is factorized by the factorization module 60 such that respective ranks of the first and second template signal factorized vectors 64,66 are both lower than a rank of the ‘d×n’ template signal matrix 30. This aspect is termed as low-rank factorization of the ‘d×n’ template signal matrix 30.

According to one aspect of the low-rank factorization, one or more individual dimensions of both the first template signal factorized vector 64 and dimensions of the second template signal factorized vector 64 are reduced as compared to dimensions of the ‘d×n’ template signal matrix 30. For example, the ‘d×n’ template signal matrix 30 may be factorized into a ‘d×d−k’ dimensional first template signal factorized vector 64 and a ‘d−k×n’ dimensional second template signal factorized vector 66. In one embodiment, ‘k’ is less than both ‘d’ and ‘n’, and d−k<d<n.

Hereinafter, “the ‘d×d−k’ dimensional first template signal factorized vector 64” will be referred to as “the ‘d×d−k’ first template matrix 64”, and “the ‘d−k×n’ dimensional second template signal factorized vector 66” will be referred to as “the ‘d−k×n’ second template matrix 66”.

Since ‘d−k’ is less than ‘d’, the rank of ‘d×d−k’ first template matrix 64 may not exceed ‘d−k’. Similarly, since ‘d−k’ is also less than ‘n’, the rank of ‘d−k×n’ second template matrix 66 may not exceed ‘d−k’, and the same is again less than ‘d’. Therefore, the ‘d×d−k’ first template matrix 66 and the ‘d−k×n’ second template matrix 66 are both low-rank factors of the ‘d×n’ template signal matrix 30.

According to an aspect, the ‘d×d−k’ first template matrix 64 and the ‘d−k×n’ second template matrix 66 are factors such that, if the ‘d×d−k’ first template matrix 64 and the ‘d−k×n’ second template matrix 66 were to be synthesized, then at least an approximation of the ‘d×n’ template signal matrix 30 is obtained, and the degree of approximation may be, for example, 80% of the ‘d×n’ template signal matrix 30. This aspect is beneficial in reducing the memory space used for the storage of ‘d×n’ template signal matrix 30, because only ‘d×d−k’ first template matrix 64 and the ‘d−k×n’ second template matrix 66 are to be stored, which consume lesser memory space as compared to storing the accurate values of the template vectors 30₁-30ₙ included in the ‘d×n’ template signal matrix 30.

Therewith, the ‘d×n’ template signal matrix 30 may be factorized into a lower rank ‘d×d−k’ first template matrix 64 and a lower rank ‘d−k×n’ second template matrix 66. The factorization of the ‘d×n’ template signal matrix 30 into two matrices 64,66 of lower ranks as compared to the rank of ‘d×n’ template signal matrix 30 may be achieved using well-known low-rank matrix approximation techniques. Certain well-known low-rank approximation techniques include Singular Value Decomposition, Principal Component Analysis, Factor Analysis, Total Least Squares Method, etc. Singular Value Decomposition simplifies the task of factorizing the ‘d×n’ template signal matrix 30 into the low-rank factors 64,66, and the same may be used for low-rank factorization of the ‘d×n’ template signal matrix 30 in accordance with an embodiment. The low-rank approximation techniques are well-known in the art, and these techniques are not described in detail herein for the purpose of brevity.

To summarize, the functioning of the factorization module 60 is such that the factorization module 60 receives any matrix as an input and provides at least two lower rank factors of the input matrix. Additionally, the lower rank factors that are therewith obtained are such that the lower rank factors upon synthesis result in at least an approximation of the input matrix.

The first multiplication module 70 of the system is, for example, operably coupled to the factorization module 60, thereby enabling data transfer between the factorization module 60 and the first multiplication module 70. The first multiplication module 70 is configured to receive the ‘d×d−k’ first template matrix 64 and the ‘l×d’ exemplary test signal vector 20₁-20ₘ. The first multiplication module 70 is configured to multiply the ‘l×d’ exemplary test signal vector 20₁-20ₘ and the ‘d×d−k’ first template matrix 64, whereby an intermediate test signal vector 75 is obtained. Dimensions of the intermediate test signal vector 75 obtained therewith are ‘l×d−k’ (e.g., the intermediate test signal vector 75 includes ‘l’ row and ‘d−k’ number of columns).

Hereinafter, the intermediate test signal vector 75 including ‘l’ row and ‘d−k’ number of columns will be referred to as ‘l×d−k’ intermediate vector 75.

The second multiplication module 80 is operably coupled to the first multiplication module 70, thereby enabling data transfer between the second multiplication module 80 and the first multiplication module 70. The second multiplication module 80 is configured to receive the ‘l×d−k’ intermediate vector 75 and the ‘d−k×n’ second template matrix 66. The second multiplication module 80 is configured to multiply the ‘l×d−k’ intermediate vector 75 and the ‘d−k×n’ second template matrix 66, wherewith a single row (e.g., the product vectors 40_{1,1}-40_{1,n}) of the ‘m×n’ product vector matrix 40 is obtained. Dimensions of the single row 40_{1,1}-40_{1,n} of the ‘m×n’ product vector matrix 40 is ‘l×n’.

Subsequent rows 40_{2,1}-40_{2,n} to 40_{m,1}-40_{m,n} of the ‘m×n’ product vector matrix 40 may be obtained by providing subsequent test signal vectors 20₁-20ₘ to the first multiplication module 70. Each of these test signal vectors 20₁-20ₘ is thereafter respectively multiplied with the ‘d×d−k’ first template matrix 64, wherewith respective subsequent ‘l×d−k’ intermediate vectors 75 are obtained. The respective subsequent ‘l×d−k’ intermediate vectors 75 are thereafter provided to the second multiplication module 80, where the respective ‘l×d−k’ intermediate vectors 75 are multiplied with the ‘d−k×n’ second template matrix 66, wherewith the respective subsequent rows 40_{2,1}-40_{2,n} of the ‘m×n’ product vector matrix 40 are obtained.

The memory unit 50 may be configured to store the ‘d×d−k’ first template matrix 64, the ‘l×d−k’ intermediate vector 75, and/or the ‘d−k×n’ second template matrix 66. The operable coupling of the memory unit 50 with the processing unit 15 enables data transfer between the memory unit 50 and the processing unit 15. The ‘d×d−k’ first template matrix 64 and the ‘d−k×n’ second template matrix 66 may be fetched by the processing unit 15 from the memory unit 50 for processing the same and for additional purposes such as the determination of the ‘m×n’ product vector matrix 40. According to another aspect, the memory unit 50 may be configured to provide the ‘d×d−k’ first template matrix 64 to the first multiplication module 70 for the purpose of computation of the ‘l×d−k’ intermediate vector 75. Similarly, the memory unit 50 may be configured to provide the ‘l×d−k’ intermediate vector 75 and the ‘d−k×n’ second template matrix 66 for the purpose of determination of the ‘m×n’ product vector matrix 40.

The system 10 in accordance with the second exemplary embodiment is depicted in FIG. 3.

The preceding figures are also referred to herein for the purpose of describing FIG. 3. The second embodiment illustrates an alternate implementation of the system 10 for obtaining the ‘m×n’ product vector matrix 40. According to the second exemplary embodiment, the processing unit 15 includes a third multiplication module 100. The third multiplication module 100 is configured to receive a random signal 90 and the ‘d×n’ template signal matrix 30, and to multiply the random signal 90 and the ‘d×n’ template signal matrix 30.

The random signal 90 is a plurality of ‘p’ number of ‘l×d’ dimensional random row vectors (not shown). The ‘p’ number of ‘l×d’ dimensional random row vectors are arranged in a row-wise manner, thereby resulting in a ‘p×d’ matrix. In one embodiment, ‘p’ is equal to ‘d’, thereby resulting in a square matrix.

According to an alternate aspect, the random signal 90 may also include a multitude of randomly selected template signal vectors 30₁-30ₙ from the plurality of template signal vectors 30₁-30ₙ.

Hereinafter, the ‘p’ number of ‘l×d’ dimensional random row vectors will be referred to as ‘p×d’ random signal matrix 90.

If ‘p’ is greater than ‘d’, then a rank of the ‘p×d’ random signal matrix 90 may not exceed ‘d’. Similarly, if ‘p’ is lesser than ‘d’, then the rank of the ‘p×d’ random signal matrix 90 may not exceed ‘p’.

By the multiplication of the ‘p×d’ random signal matrix 90 and the ‘d×n’ template signal matrix 30, a quasi product vector 110 is obtained. The quasi product vector 110 is represented as a ‘p×n’ dimensioned matrix, and will be hereinafter referred to as ‘p×n’ quasi product matrix 110. The ‘p×n’ quasi product matrix 110 is an intermediate matrix that is beneficial in the determination of the ‘m×n’ product vector matrix 40.

If ‘p’ is greater than ‘n’, then a rank of the ‘p×n’ quasi product matrix 110 may not exceed ‘n’. Similarly, if ‘p’ is lesser than ‘n’, then the rank of the ‘p×n’ quasi product matrix 110 may not exceed ‘p’.

In accordance with this embodiment, the factorization module 60 is configured to receive the ‘p×n’ quasi product matrix 110, and to factorize the ‘p×n’ quasi product matrix 110 to obtain low-rank factors of the ‘p×n’ quasi product matrix 110. The ‘p×n’ quasi product matrix 110 is factorized to obtain at least two low-rank factors of the same (e.g., a first quasi product factorized vector 114 and a second quasi product factorized vector 116).

Low-rank factorization of the ‘p×n’ quasi product matrix 110 is achieved by performing any of the low-rank factorization techniques on the ‘p×n’ quasi product matrix 110 (e.g., by performing Singular Value Decomposition of the ‘p×n’ quasi product matrix 110).

According to one aspect of the low-rank factorization, one or more individual dimensions of both the first quasi product factorized vector 114 and dimensions of the second quasi product factorized vector 116 are reduced as compared to dimensions of the ‘p×n’ quasi product matrix 110. For example, the ‘p×n’ quasi product matrix 110 may be factorized into a ‘p×p−k’ dimensional first quasi product factorized vector 114 and a ‘p−k×n’ dimensional second quasi product factorized vector 116. In one embodiment, ‘k’ may be less than both ‘p’ and ‘n’.

Hereinafter, “the ‘p×p−k’ dimensional first quasi product factorized vector 114” will be referred to as “the ‘p×p−k’ first quasi matrix 114”, and “the ‘p−k×n’ dimensional second quasi product factorized vector 116” will be referred to as “the ‘p−k×n’ second quasi matrix 116.”

The rank of ‘p×p−k’ first quasi matrix 114 may not exceed ‘p−k’, and the same is less than ‘p’. Similarly, the rank of ‘p−k×n’ second quasi matrix 116 may not exceed ‘p−k’, which is again less than ‘p’. Therefore, the ‘p×p−k’ first quasi matrix 114 and the ‘p−k×n’ second quasi matrix 116 are both low-rank factors of the ‘p×n’ quasi product matrix 114.

According to an aspect, the ‘p×p−k’ first quasi matrix 114 and the ‘p−k×n’ second quasi matrix 116 are factors such that, if the ‘p×p−k’ first quasi matrix 114 and the ‘p−k×n’ second quasi matrix 116 were to be synthesized, then at least an approximation of the ‘p×n’ quasi product matrix 110 is obtained, and the degree of approximation may be, for example, 80% of the ‘p×n’ quasi product matrix 110. This aspect is beneficial in reducing the memory space used for the storage of ‘p×n’ quasi product matrix 110, because only ‘p×p−k’ first quasi matrix 114 and the ‘p−k×n’ second quasi matrix 116 are to be stored, which consume lesser memory space as compared to storing the ‘p×n’ quasi product matrix 110.

An inversion module 120 included in the system 10 is configured to receive the ‘p×d’ random signal matrix 90 for the purpose of inverting the ‘p×d’ random signal matrix 90. An inverse random signal matrix 125 is therewith obtained, where the inverse random signal matrix 125 includes ‘d’ number of rows and ‘p’ number of columns.

Hereinafter, the inverse random signal matrix 125 will be referred to as ‘d×p’ inverse matrix 125. The ‘d×p’ inverse matrix 125 may also be a pseudo-inverse of ‘p×d’ random signal matrix 90, if ‘p’ and ‘d’ are unequal.

A fourth multiplication module 130 included in the system is configured to receive the ‘d×p’ inverse matrix 125 and the ‘p×p−k’ first quasi matrix 114, and configured to multiply the ‘d×p’ inverse matrix 125 and the ‘p×p−k’ first quasi matrix 114. By the multiplication of the ‘d×p’ inverse matrix and the ‘p×p−k’ first quasi matrix, a first intermediate quasi matrix 134 is obtained. The first intermediate quasi matrix 134 includes ‘d’ number rows and ‘p−k’ number of columns.

Hereinafter, the first intermediate quasi matrix 134 including ‘d’ number rows and ‘p−k’ number of columns will be referred to as ‘d×p−k’ first intermediate quasi matrix 134.

The ‘d×p−k’ first intermediate quasi matrix 134 may also be the ‘d×d−k’ first template matrix 64, if the multiplication of the ‘d×p’ inverse matrix 125 and the ‘p×p−k’ first quasi matrix 114 were to annul the effect of the multiplication of the ‘p×d’ random signal matrix 125 and the ‘d×n’ template signal matrix 30, and the subsequent factorization of the ‘p×n’ quasi product matrix 110 into the ‘p×p−k’ first quasi matrix 114 and the ‘p−k×n’ second quasi matrix 116.

In accordance with the present embodiment, the first multiplication module 70 is configured to receive the exemplary ‘m×d’ test signal matrix 20 and the ‘d×p−k’ first intermediate quasi matrix 134, and also configured to multiply the ‘m×d’ test signal matrix 20 and the ‘d×p−k’ first intermediate quasi matrix 134. By the multiplication of the ‘m×d’ test signal matrix 20 and the ‘d×p−k’ first intermediate quasi matrix 134, a second intermediate quasi matrix 136 is obtained. The second intermediate quasi matrix 136 includes ‘m’ number of rows and ‘p−k’ number of columns.

Hereinafter, the second intermediate quasi matrix 136 including ‘m’ number of rows and ‘p−k’ number of columns will be referred to as ‘m×p−k’ second intermediate quasi matrix 136.

In furtherance to the aforementioned, in accordance with the present embodiment, the second multiplication module 80 is configured to receive the ‘m×p−k’ second intermediate quasi matrix 136 and the ‘p−k×n’ second quasi matrix 116, and also configured to multiply the ‘m×p−k’ second intermediate quasi matrix 136 and the ‘p−k×n’ second quasi matrix 116. By the multiplication of the ‘m×p−k’ second intermediate quasi matrix 136 and the ‘p−k×n’ second quasi matrix 116, the ‘m×n’ product vector matrix 40 is therewith obtained. The ‘m×n’ product vector matrix 40 may be stored in the memory unit 50 and retrieved later (e.g., for further processing of the ‘m×n’ product vector matrix 40 for any signal processing application).

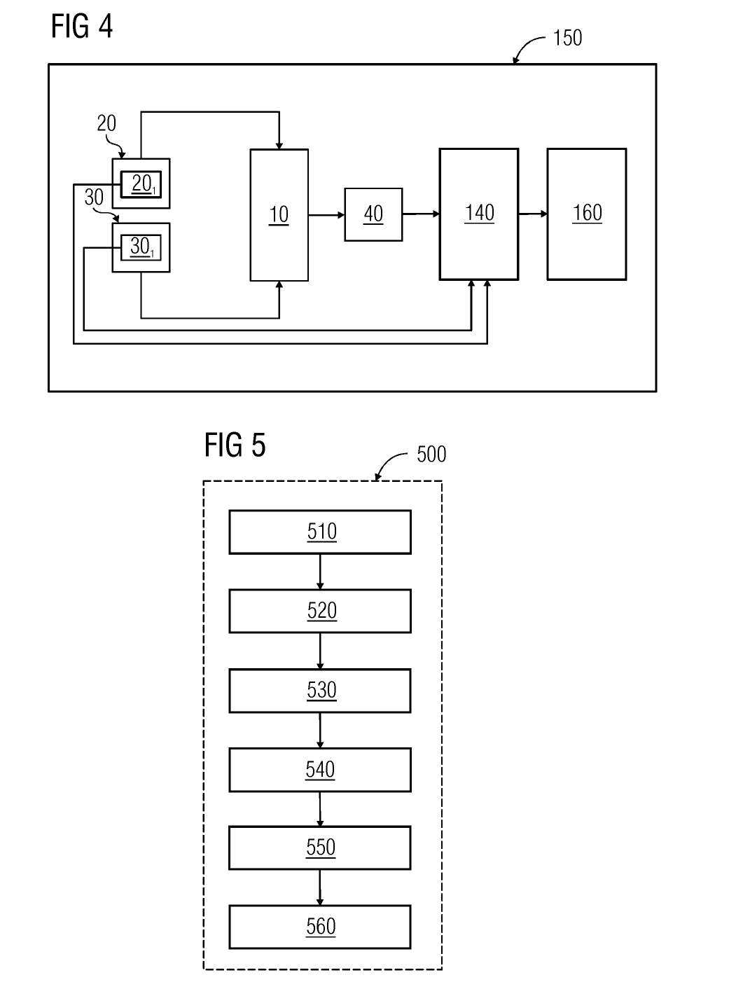

The ‘m×n’ product vector matrix 40 determined in accordance with the description above is beneficial in the determination of respective Euclidean distances between the respective ‘m’ number of plurality of test signal vectors 20 and the respective ‘n’ number of plurality of template signal vectors 30. Thereafter, the Euclidean distances may be used for performing Dynamic Time Warping of the test signal vector 20₁-20ₘ with the plurality of ‘n’ number of template signal vectors 30. These aspects are described with reference to FIG. 4 for exemplary and illustrative purposes.

The system 10 including the factorization module 60, the first multiplication module 70 and the second multiplication module 80 may be realized as a single hardware unit, where different entities of the hardware unit are configured to perform the functions of the factorization module 60, the first multiplication module 70 and the second multiplication module 80. For example, the system 10 depicted in FIG. 2 may be realized on a Field Programmable Gate Array Device that includes a plurality of Configurable Logic Blocks. A first set of the Configurable Logic Blocks may be configured to perform one or more functions associated with the factorization module 60, and a second set of the Configurable Logic Blocks may be configured to perform one or more functions associated with the first multiplication module 70. A third set of the Configurable Logic Blocks may be configured to perform one or more functions associated with the second multiplication module 80, etc.

A Dynamic Time Warping Block 150 including the system 10 in accordance with any of the aforementioned embodiments is depicted in FIG. 4.

One or more of the preceding figures are also referred to herein for the Dynamic Time Warping Block 150 depicted in FIG. 4. The Dynamic Time Warping Block 150 is beneficial for determining a similarity between one or more of the plurality of the test signal vectors 20 and the plurality of template signal vectors 30. The Dynamic Time Warping Block 150 includes the system 10 in accordance with any of the aforementioned embodiments, a Euclidean Distance Matrix Computation module 140, and a Dynamic Time Warping Score computation module 160. In FIG. 1, the system 10 is shown to be located internal to the Dynamic Time Warping Block 150. However, according to an alternate aspect, and without loss of any generality, the system 10 may also be located external to the Dynamic Time Warping Block 150.

The Euclidean Distance Matrix Computation module 140 is configured to receive the ‘m×n’ product vector matrix 40, the ‘m×d’ test signal matrix 20, and the ‘d×n’ template signal matrix 30 as inputs. The Euclidean Distance Matrix Computation module 140 is configured to determine an ‘m×n’ Euclidean Distance Matrix (not depicted) that includes a plurality of Euclidean distances (not depicted). Each Euclidean distance thereby determined signifies a respective distance between a certain test signal vector 20₁-20ₘ (e.g., included in the ‘m×d’ test signal matrix 20) and a certain template signal vector 30₁-30ₙ (e.g., included in the ‘d×n’ template signal matrix 30). The collection of such respective Euclidean distances between each of the respective test signals 20₁-20ₘ and each of the respective template signals 30₁-30ₙ constitutes the ‘m×n’ Euclidean Distance Matrix, which is the output provided by the ‘m×n’ Euclidean Distance Matrix Computation module. The determination of the ‘m×n’ Euclidean Distance Matrix based upon the provision of the ‘m×d’ test signal matrix 20, the ‘d×n’ template signal matrix 30, and the ‘m×n’ product vector matrix 40, and the implementation of the Euclidean Distance Matrix Computation module 140 are well-known in the art, and is not described herein for the purpose of brevity.

Thereafter, the ‘m×n’ Euclidean Distance Matrix is provided to the Dynamic Time Warping Score computation module 160 for performing Dynamic Time Warping of the plurality of test signals 20 and the plurality of template signals 30. Herewith, an ‘m×n’ Global Distance Matrix (not depicted) is determined for the test signals 20₁-20ₘ represented in the ‘m×d’ test signal matrix 20 and for the template signals 30₁-30ₙ included in the ‘d×n’ template signal matrix 30. Thereby, a Dynamic Time Warping Score purporting to the similarity of a certain test signal 20₁-20ₘ with any of the template signals 30₁-30ₙ is determinable. The determination of the Dynamic Time Warping Score (e.g., the determination of the ‘m×n’ Global Distance Matrix) by the performance of Dynamic Time Warping of the plurality of test signals 20 and the plurality of template signals 30 based on the ‘m×n’ Euclidean Distance Matrix is well-known in the art and is not discussed herein for the purpose of brevity.

A flowchart 500 of an overview of a method for determining the product vectors 40_{1,1}-40_{m,n} from the test signal vectors 20₁-20ₘ and the template signal vector 30₁-30ₙ in accordance with one or more embodiments is shown in FIG. 5.

Reference is made to one or more of the preceding figures for the description of the flowchart 500.

In acts 510 and 520, the test signal vector 20₁-20ₘ and the template signal vector 30₁-30ₙ are received, respectively. The test signal vector 20₁-20ₘ and the template signal vector 30₁-30ₙ are represented as ‘m×d’ test signal matrix 20 and ‘d×n’ template signal matrix 30, respectively. According to one aspect, the ‘m×d’ test signal matrix 20 and ‘d×n’ template signal matrix 30 may be stored in the memory unit 50, and the memory unit 50 may thereafter be queried by the processing unit 15 to receive the ‘m×d’ test signal matrix 20 and ‘d×n’ template signal matrix 30.

In act 530, the ‘d×n’ template signal matrix 30 is factorized into the ‘d×d−k’ first template matrix 64 and the ‘d−k×n’ second template matrix 66, which are low-rank factors of the ‘d×n’ template signal matrix 30. In accordance with an embodiment of the present method, the low-rank factors (e.g., ‘d×d−k’ first template matrix 64 and the ‘d−k×n’ second template matrix 66) are obtained by performing Singular Value Decomposition of the ‘d×n’ template signal matrix 30. The act 530 may be performed by providing the ‘d×n’ template signal matrix 30 to the factorization module 60 for the purpose of low-rank factorization of the ‘d×n’ template signal matrix 30. For example, the low-rank factorization of the ‘d×n’ template signal matrix 30 may be achieved by performing Singular Value Decomposition on the ‘d×n’ template signal matrix 30.

In act 540, the ‘l×d’ exemplary test signal vector 20₁ and the ‘d×d−k’ first template matrix 64 are multiplied, wherewith the intermediate test signal vector 75 is obtained. The act 540 may be performed by providing the ‘l×d’ exemplary test signal vector 20₁ and the ‘d×d−k’ first template matrix 64 to the first multiplication module 70 for the purpose of multiplication of the ‘l×d’ exemplary test signal vector 20₁ and the ‘d×d−k’ first template matrix 64.

In act 550, the ‘l×d−k’ intermediate vector 75 and the ‘d−k×n’ second template matrix 66 are multiplied, wherewith the single row 40_{1,1}-40_{1,n} (e.g., of dimensions ‘l×n’) of the ‘m×n’ product vector matrix 40 is obtained. The act 550 may be performed by providing the ‘l×d−k’ intermediate vector 75 and the ‘d−k×n’ second template matrix 66 to the second multiplication module 80 for the purpose of multiplication of the ‘l×d−k’ intermediate vector 75 and the ‘d−k×n’ second template matrix 66.

Subsequent rows 40_{2,1}-40_{2,n} to 40_{m,1}-40_{m,n} of the ‘m×n’ product vector matrix 40 may be obtained by sequential repetition of the acts 540 and 550 for each of the subsequent test signal vectors 20₂-20ₘ. Different test signal vectors 20₂-20ₘ are provided to the first multiplication module 70, where the ‘d×d−k’ first template matrix 64 remains the same. Therewith, respective subsequent ‘l×d−k’ intermediate vectors 75, which are thereafter provided to the second multiplication module 80 for the purpose of determination of the respective subsequent rows 40_{2,1}-40_{2,n} to 40_{m,1}-40_{m,n} of the ‘m×n’ product vector matrix 40, are obtained. In the second multiplication module 80, the ‘d−k×n’ second template matrix 66 remains the same.

Thereafter, in act 560, the ‘m×n’ product vector matrix 40 obtained therewith is stored in the memory unit 50. The ‘m×n’ product vector matrix 40 may be provided to the processing unit 15 at a subsequent stage for the purpose of processing the same in the context of a signal processing application, such as Dynamic Time Warping, Data Compression, Data Indexing, etc.

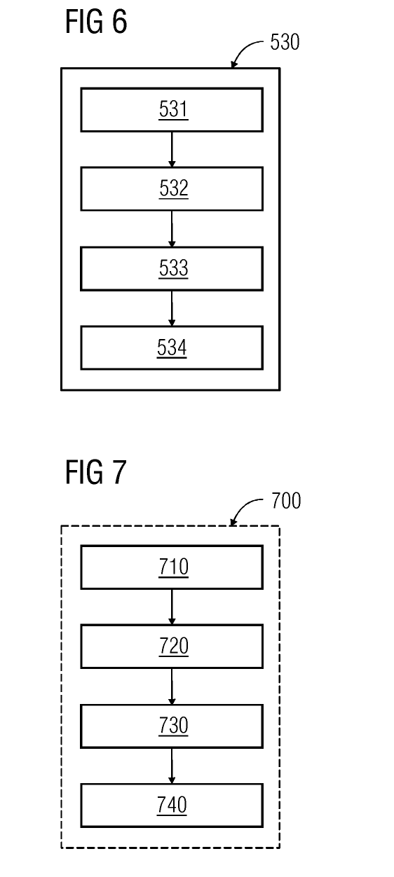

Certain acts included in the act 530, which is related to the factorization of the ‘d×n’ template signal matrix 30, in accordance with an alternate embodiment are shown in FIG. 6.

In act 531, the ‘p×d’ random signal matrix 90 and the ‘d×n’ template signal matrix 30 are multiplied, wherewith the ‘p×n’ quasi product matrix 110 is obtained. The act 531 may be performed by providing the ‘p×d’ random signal matrix 90 and the ‘d×n’ template signal matrix 30 to the third multiplication module 100 for the purpose of multiplication of the ‘p×d’ random signal matrix 90 and the ‘d×n’ template signal matrix 30.

Thereafter, in act 532, ‘p×n’ quasi product matrix 110 is low-rank factorized into the ‘p×p−k’ first quasi matrix 114 and the ‘p−k×n’ second quasi matrix 116. The act 532 may be performed by providing ‘p×n’ quasi product matrix 110 to the factorization module 60, and the low-rank factors of the same may be obtained by performing Singular Value Decomposition on the ‘p×n’ quasi product matrix 110.

In act 533, ‘d×p’ inverse matrix 125 and the ‘p×p−k’ first quasi matrix 114 are multiplied, wherewith the ‘d×p−k’ first intermediate quasi matrix 134 is obtained. The act 533 may be performed by providing the ‘d×p’ inverse matrix 125 and the ‘p×p−k’ first quasi matrix 114 to the fourth multiplication module 130 for the purpose of multiplication of the ‘d×p’ inverse matrix 125 and the ‘p×p−k’ first quasi matrix 114.

The ‘d×p’ inverse matrix 125 may be obtained by providing the ‘p×d’ random signal matrix 90 to the inversion module 120 for the purpose of determination of the inverse of the ‘p×d’ random signal matrix 90.

In act 534, the ‘p×p−k’ first quasi matrix 114 and the ‘p−k×n’ second quasi matrix 116 obtained therewith are stored in the memory unit 50. The ‘p×p−k’ first quasi matrix 114 and the ‘p−k×n’ second quasi matrix 116 may be provided to the processing unit 115 at another subsequent stage for the purpose of processing the same for the determination of the ‘m×n’ product vector matrix 40.

The ‘m×n’ product vector matrix 40 obtained in accordance with the aforementioned acts may be used for the purpose of performing Dynamic Time Warping of the plurality of test signals 20₁-20ₘ and the plurality of template signals 30₁-30ₙ.

A flowchart 700 of one embodiment of a method for performing Dynamic Time Warping of the test signals 20₁-20ₘ and the template signals 30₁-30ₙ is shown in FIG. 7.

In act 710, the ‘m×n’ product vector 40 is received. In accordance with one aspect, the ‘m×n’ product vector 40 is stored in the memory unit 50, and the memory unit 50 may thereafter be queried by the processing unit 15 to receive ‘m×n’ product vector 40.

In act 720, the test signal vector 20₁-20ₘ (e.g., ‘m×d’ test signal matrix 20) and the template signal vector 30₁-30ₙ (e.g., ‘d×n’ template signal matrix 30) are received respectively. The memory unit 50 may be queried by the processing unit 15 to receive the ‘m×d’ test signal matrix 20 and ‘d×n’ template signal matrix 30.

Thereafter, in act 730, the ‘m×n’ Euclidean Distance Matrix is determined. The act 730 may be performed by providing the ‘m×n’ product vector matrix 40, the ‘m×d’ test signal matrix 20, and the ‘d×n’ template signal matrix 30 to the Euclidean Distance Matrix Computation module 140 for the purpose of determination of the ‘m×n’ Euclidean Distance Matrix.

In a subsequent act 740, the Dynamic Time Warping Score is determined. The act 740 may be performed by providing the ‘m×n’ Euclidean Distance Matrix to the Dynamic Time Warping Score computation module 160. The ‘m×n’ Global Distance Matrix is determined. The Dynamic Time Warping Score for the plurality of test signals 20₁-20ₘ and the plurality of template signals 30₁-30ₙ is obtained.

In accordance with an aspect, the plurality of template vectors 30 may also be a concatenation of a plurality of groups of template vectors. Each group of template vectors includes the template vectors that belong to a certain signal class. In such a scenario, the ‘m×n’ product vector matrix 40 may be determined on a per-class basis (e.g., corresponding product vector may be determined for the plurality of test signals 20 and an individual group of template vectors). For facilitating the determination of the product vector on a per-class basis, for each group including template vectors, respective low-rank factors are determined, and the plurality of test signals 20 is multiplied with the respective low-rank factors corresponding to that particular group of template vectors in accordance with the teachings of one or more of the present embodiments in order to obtain the corresponding product vector.

The per-class based technique is beneficial for performing Dynamic Time Warping based classification of the plurality of test signals 20 if multiple classes of template vectors are present. Individual product vectors may be determined on a per-class basis for the purpose of determination of the corresponding Euclidean Distance Matrices. The corresponding Euclidean Distance Matrices are thereafter utilized for obtaining Dynamic Time Warping scores on a per-class basis, therewith increasing the speed and reliability of the Dynamic Time Warping Block 150. In the per-class based implementation of the Dynamic Time Warping Block 150, multiple processing units may be utilized. Each processing unit may be configured to determine a certain product vector for a certain class of template signal vectors 20, the corresponding Euclidean Distance Matrix, and the corresponding Dynamic Time Warping Score. The multiple processing units of the Dynamic Time Warping Block 150 may be configured to operate in parallel, wherewith the speed of Dynamic Time Warping Block is further enhanced.

Though the invention has been described herein with reference to specific embodiments, this description is not meant to be construed in a limiting sense. Various examples of the disclosed embodiments, as well as alternate embodiments, will become apparent to persons skilled in the art upon reference to the description. Such modifications may be made without departing from the embodiments of the present invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for determining a product vector for determining a Euclidean distance between a test signal vector and at least a template signal vector, wherein the test signal vector comprises vectorized values of at least a portion of a test signal, and wherein the template signal vector comprises vectorized values of a template signal, the method comprising:
factorizing, by a processor, the template signal vector for obtaining at least a first template signal factorized vector and a second template signal factorized vector of the template signal vector, wherein respective ranks of the first template signal factorized vector and the second template signal factorized vector are both less than a rank of the template signal vector;
multiplying, by the processor, the test signal vector and the first template signal factorized vector for obtaining an intermediate test signal vector, wherein a rank of the intermediate test signal vector is less than or equal to a rank of the test signal vector; and
multiplying, by the processor, the intermediate test signal vector and the second template signal factorized vector for determining the product vector.

2. The method of claim 1, wherein a product of the first template signal factorized vector and the second template signal factorized vector is at least an approximation of the template signal vector.

3. The method of claim 1, wherein the first template signal factorized vector and the second template signal factorized vector are obtained by performing Singular Value Decomposition of the template signal vector.

4. The method of claim 1, wherein in the factorizing of the template signal vector, the obtaining of the first template signal factorized vector comprises:
multiplying a random signal with the template signal vector for obtaining a quasi product vector, wherein the random signal comprises a plurality of random signal vectors, wherein each random signal vector of the plurality of the random signal vectors comprises a plurality of random values;
factorizing the quasi product vector for obtaining a first quasi product factorized vector and a second quasi product factorized vector for the quasi product vector, wherein respective ranks of the first quasi product factorized vector and the second quasi product factorized vector are both less than a rank of the quasi product vector; and
multiplying the first quasi product factorized vector with an inverse random signal for obtaining the first template signal factorized vector, wherein the inverse random signal is an inverse of the random signal.

5. The method of claim 4, wherein the second quasi product factorized vector is the second template signal factorized vector.

6. The method of claim 4, wherein the first quasi product factorized vector and the second quasi product factorized vector are obtained by performing Singular Value Decomposition of the quasi product factorized vector.

7. A method for performing Dynamic Time Warping between a test signal vector and at least a template signal vector, wherein the test signal vector comprises vectorized values of at least a portion of a test signal, and wherein the template signal vector comprises vectorized values of a template signal, the method comprising:
determining, by a processor, a product vector of the test signal vector and the template signal vector, wherein the determining comprises factorizing the template signal vector for obtaining at least a first template signal factorized vector and a second template signal factorized vector of the template signal vector, wherein respective ranks of the first template signal factorized vector and the second template signal factorized vector are both less than a rank of the template signal vector, wherein the determining further comprises multiplying the test signal vector and the first template signal factorized vector for obtaining an intermediate test signal vector, wherein a rank of the intermediate test signal vector is less than or equal to a rank of the test signal vector, wherein the determining further comprises multiplying the intermediate test signal vector and the second template signal factorized vector for determining the product vector;
processing, by the processor, the product vector for determining a Euclidean distance between the test signal vector and the template signal vector; and
processing, by the processor, the Euclidean distance for determining a global distance between the test signal vector and the template signal vector, wherein the global distance represents a Dynamic Time Warping Score for the test signal vector and the template signal vector, and wherein the Dynamic Time Warping Score represents a similarity between the test signal vector and the template signal vector.

8. A system for determining a product vector from a test signal vector and a template signal vector, wherein the test signal vector comprises vectorized values of at least a portion of a test signal, and wherein the template signal vector comprises vectorized values of a template signal, the system comprising:
a processor configured for:
factorizing the template signal vector for obtaining a first template signal factorized vector and a second template signal factorized vector for the template signal vector;
multiplying the test signal vector and the first template signal factorized vector for obtaining an intermediate test signal vector; and
multiplying the second template signal factorized vector and the intermediate test signal vector for obtaining the product vector.

9. The system of claim 8, wherein respective ranks of the first template signal factorized vector and the second template signal factorized vector are both less than a rank of the template signal vector, and
wherein a rank of the intermediate test signal vector is less than or equal to a rank of the test signal vector.

10. The system of claim 8, wherein the processor is further configured to factorize the template signal vector, such that the product of the first template signal factorized vector and the second template signal factorized vector is at least an approximation of the template signal vector.

11. The system of claim 8, wherein the processor is further configured to factorize the template signal vector by performing Singular Value Decomposition of the template signal vector for obtaining the first template signal factorized vector and the second template signal factorized vector.

12. The system of claim 11, wherein the processor is further configured for multiplying the random signal and the template signal vector for obtaining the quasi product vector.

13. The system of claim 12, wherein the processor is further configured to factorize a quasi product vector for obtaining the first quasi product factorized vector and the second quasi product factorized vector from the quasi product vector, wherein the second quasi product factorized vector is the second template signal factorized vector.

14. The system of claim 13, wherein the processor is further configured for multiplying an inverse random signal and the first quasi product factorized vector for obtaining the first template signal factorized vector.

15. The system of claim 14, wherein the processor is further configured to multiply the first template signal factorized vector and the second quasi product factorized vector for obtaining the product vector.

16. The system of claim 8, further comprising a memory unit configured for storing the test signal vector, the template signal vector, the product vector, the first template signal factorized vector, the second template signal factorized vector, or any combination thereof.

17. A Dynamic Time Warping Block for Dynamic Time Warping a test signal vector and at least a template signal vector, wherein the test signal vector comprises vectorized values of at least a portion of a test signal, and wherein the template signal vector comprises vectorized values of a template signal, the Dynamic Time Warping Block comprising:
a system for determining a product vector of the test signal vector and the template signal vector, the system comprising a processor configured for factorizing the template signal vector for obtaining a first template signal factorized vector and a second template signal factorized vector for the template signal vector, multiplying the test signal vector and the first template signal factorized vector for obtaining an intermediate test signal vector, and multiplying the second template signal factorized vector and the intermediate test signal vector for obtaining the product vector;
a Euclidean Distance Matrix Computation module configured to process the test signal vector, the template signal vector and the product vector or determining a Euclidean distance between the test signal vector and the template signal vector based on the product vector; and
a Dynamic Time Warping Score computation module configured to process the Euclidean distance for determining a global distance between the test signal vector and the template signal vector, wherein the global distance represents a Dynamic Time Warping Score for the test signal vector and the template signal vector, and wherein the Dynamic Time Warping Score represents a similarity between the test signal vector and the template signal vector.
